(19) United States
(12) Patent Application Publication
(10) Pub. No.: US 2025/0115074 A1
(43) Pub. Date: Apr. 10, 2025

(54) SYSTEM AND METHOD FOR DISPLAYING HARVESTED GAME ANIMALS

(71) Applicant: Chad Ryan Davis, Columbia, TN (US)

(72) Inventor: Chad Ryan Davis, Columbia, TN (US)

(21) Appl. No.: 18/900,699

(22) Filed: Sep. 28, 2024

Related U.S. Application Data
(60) Provisional application No. 63/543,436, filed on Oct. 10, 2023.

(51) Int. Cl. B44C 5/02; F16M 13/02

(52) U.S. Cl. CPC B44C 5/02; F16M 13/02

(57) ABSTRACT

A mounting system for displaying hunting trophies includes a mounting plate for attachment to a wall, a trophy mount assembly configured to retain a portion of a game animal, such as a skull, antlers, etc., and a telescoping tube assembly operatively interconnecting the trophy mount assembly and the mounting plate. The telescoping tube assembly enables a user to alter the distance between the trophy mount assembly (any any hunting trophy retained thereby) and the mounting plate and the wall to which it is attached. Other features may include a joint assembly interconnecting the telescoping tube assembly and the mounting plate to provide three axes of adjustability, and an insert member that is readily detachable from the mounting plate to enable a user to display other trophies from the mounting plate.

### CROSS-REFERENCE TO RELATED APPLICATION

This application claims the benefit of U.S. Provisional Patent Application No. 63/543,436, filed Oct. 10, 2023, and which is hereby incorporated by reference in its entirety.

### TECHNICAL FIELD

This disclosure relates to mounts for displaying objects, and more particularly to mounts for displaying portions of harvested game animals.

### BACKGROUND OF THE INVENTION

Hunters often enjoy keeping and displaying a portion of a harvested game animal, such as antlers, heads, skulls, etc., as a trophy and reminder of a particular hunting experience. These trophy displays may also act as a decoration or enhance the aesthetics of a room. Typically, the portion of the harvested game animal is connected to a mounting apparatus that enables placement of the trophy on a wall.

### SUMMARY

A mounting system for displaying hunting trophies is provided herein. The mounting system improves upon the prior art by facilitating the process of mounting trophies, and by providing modularity and interchangeability for the user. According to a first aspect of the disclosure, a system for mounting hunting trophies to a wall or other surface includes a mounting plate, a telescoping tube assembly having a first tube and a second tube, and a trophy mount assembly configured to hold a portion of a harvested game animal. The first tube is selectively slidable relative to the second tube to change the length of the telescoping tube assembly, and thereby change the distance between the mounting plate and the trophy mount assembly.

According to a second aspect of the disclosure, the first tube is operatively connected to the mounting plate via a joint assembly that provides three axes of rotation to enable significant movement of the trophy mount assembly relative to the mounting plate. In one embodiment, the joint assembly includes a Hirth joint.

According to a third aspect of the disclosure, the mounting plate defines a slot that is upwardly-open when the mounting plate is attached to a wall. An insert member is operatively connected to the first tube and/or the joint assembly and is insertable into the slot and thereby connect the trophy mount assembly to the mounting plate. When the insert member is fully engaged with the mounting plate, physical part interference between the insert member and the mounting plate substantially prevents relative movement of the insert member relative to the mounting plate except upward movement of the insert member.

The system thus enables a user to rapidly and easily replace one trophy with another trophy, including trophies of different styles or configurations, by lifting the insert member from the slot, and then lowering another insert member having another trophy mount assembly into the slot.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a front view of a mounting plate;

FIG. 2 is a side view of the mounting plate of FIG. 1;

FIG. 3 is a top view of an insert member;

FIG. 4 is a front view of the insert member of FIG. 3;

FIG. 5 is a side view of the insert member of FIGS. 3-4;

FIG. 6 is a perspective view of a first trophy mounting assembly having an insert member positioned to be lowered into engagement with the mounting plate;

FIG. 7 is a perspective view of the insert member engaged with the mounting plate to operatively connect the first trophy mounting assembly to the mounting plate;

FIG. 8 is a top view of a joint member;

FIG. 9 is a side view of the joint member of FIG. 8;

FIG. 10 is a perspective view of a second trophy mounting assembly;

FIG. 11 is another perspective view of the second trophy mounting assembly;

FIG. 12 is a perspective view of a third trophy mounting assembly including a telescoping arm assembly mounting assembly;

FIG. 13 is a perspective view of a table-top mounting apparatus having a mounting plate for compatibility with any mounting assembly having the insert member;

FIG. 14 is a schematic, perspective view of a fourth mounting assembly;

FIG. 15A is a side view of the telescoping arm assembly in a retracted position and having a first length;

FIG. 15B is a side view of the telescoping arm assembly in an extended position and having a second length;

FIG. 16 is a schematic, front view of an alternative mounting plate; and

FIG. 17 is a schematic, perspective view of the first trophy mounting assembly connected to the telescoping arm assembly.

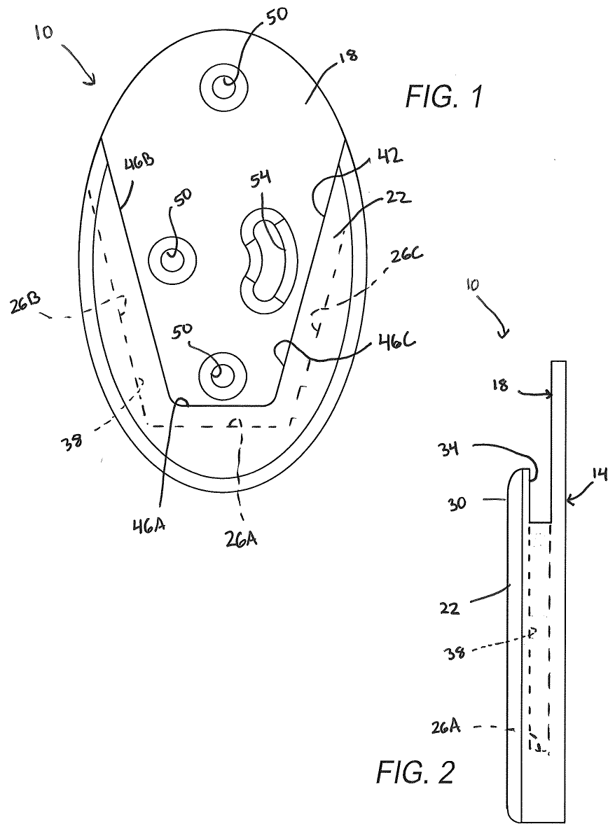

### DETAILED DESCRIPTION

Referring to the Figures, wherein like reference numbers refer to like components throughout, a mounting system is schematically depicted. The mounting system includes at least one mounting plate 10. The mounting plate 10 in the embodiment depicted is generally elliptical or oval in shape, and includes a first surface 14 that is substantially planar. A second surface 18 on the opposite side of the mounting plate 10 from the first surface 14 is substantially planar. Surfaces 14 and 18 face opposite directions from each other.

The mounting plate 10 includes structure 22 that defines three surface segments 26A, 26B, 26C that extend perpendicularly from the second surface 18. Segments 26B and 26C each form an angle of between 90 degrees and 135 degrees with segment 26A. Structure 22 also includes a portion 30 that defines a third surface 34. The third surface 34 is substantially parallel to the second surface 18. The third surface 34 extends from segments 26A, 26B, 26C. The third surface 34, the surface segments 26A, 26B, 26C, and the second surface 18 cooperate to define a slot 38.

The portion 30 also defines a notch 42. More specifically, the portion 30 includes three edges 46A, 46B, 46C that cooperate to define the notch 42. In the embodiment depicted, edge 46A is parallel with segment 26A; edge 46B is parallel with segment 26B; and edge 46C is parallel with segment 26C.

The mounting plate 10 defines a plurality of holes 50 and an arcuate slot 54 that extend through surfaces 14 and 18. The holes 50 and slot 54 enable fasteners to be driven therethrough to attach the mounting plate 10 to a wall or other surface such that the first surface 14 abuts the wall. The slot 54 enables angular adjustment during the attachment process. It should be noted that the notch 42 is positioned so that some of the holes 50, 54 are accessible through the notch 42 and therefore none of the holes 50, 54 are obstructed by portion 30.

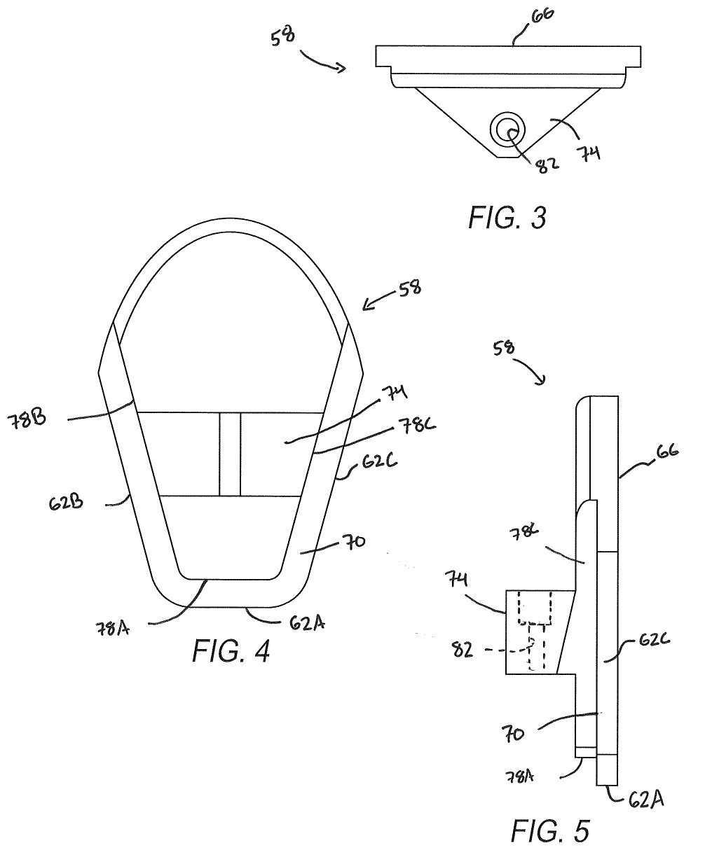

The mounting plate 10 forms a portion of a system for mounting hunting trophies. The system also includes at least one insert member 58. As shown in FIGS. 3-5, the insert member 58 includes surface segments 62A, 62B, 62C that form a portion of the periphery of the member 58. Surface segments 62A, 62B, 62C have substantially the same geometric relationship with each other as segments 26A, 26B, 26C have with each other. For example, the angle formed between segments 62A and 62B is substantially the same as the angle formed between segments 26A and 26B.

The insert member has a surface 66 that is substantially planar, and another surface 70 that is substantially planar and parallel to surface 66. The insert member 58 has a portion 74 that is protuberant from surface 70 and that includes edges 78A, 78B, 78C. Edge 78A is parallel with segment 62A; edge 78B is substantially parallel with segment 62B; and edge 78C is substantially parallel with segment 62C.

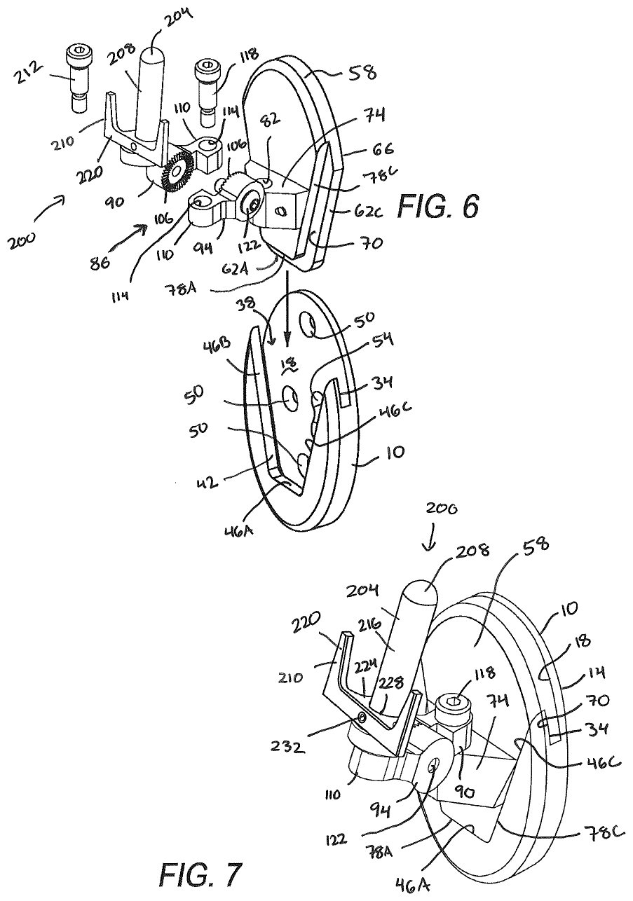

The distance between surfaces 66 and 70 is marginally less than the distance between surface 18 and surface 34 of structure 22. Accordingly, when the mounting plate 10 is attached to a wall or other surface such that segment 26A is horizontal and forms the lowermost extent of the slot 38, the insert member 58 is engageable with the mounting plate 10 by lowering the insert member 58 relative to the mounting plate 10 into the slot 38 so that surface 66 abuts surface 18, surface 70 abuts surface 34 of the structure 22, segment 62A abuts segment 26A, segment 62B abuts segment 26B, segment 62C abuts segment 26C, edge 78A abuts edge 46A, edge 78B abuts edge 46B, and edge 78C abuts edge 46C, as best shown in FIGS. 6 and 7.

When the insert member 58 is engaged with the mounting plate 10, i.e., fully inserted into the slot 38 as shown in FIG. 7, physical part interference between the mounting plate 10 and the insert member 58 prevents or restricts movement of the insert member 58 relative to the mounting plate in all directions except in a single direction. When the mounting plate is installed in the use position described, the single direction is upward.

The insert member 58 defines an aperture 82 that extends through the protuberant portion 74 such that the axis of the aperture 82 is vertical when the insert member 58 is engaged with the mounting plate 10.

The system also includes a plurality of differently-configured trophy mount assemblies 200, 300, 400, 500. Trophy mount assembly 200 is configured for mounting a skull. Trophy mount assembly 300 is configured for mounting antlers (without a skull or portion of a skull). Trophy mount assembly 400 is configured for mounting a skull plate (i.e., partial skull) with antlers. Trophy mount assembly 500 is configured for mounting a skull or artificial skull.

Each of the trophy mount assemblies 200, 300, 400, 500 includes a respective insert member 58. All of the insert members 58 are identical to one another, and therefore each of the assemblies 200, 300, 400, 500 is engageable with a single mounting plate 10, thereby providing modularity and flexibility to a user. A method of using the system may include attaching a mounting plate 10 to a wall, and engaging the insert member 58 of a trophy mount assembly 200 with the mounting plate 10, i.e., inserting the insert member 58 into the slot 38 of the mounting plate 10 to restrict movement of the insert member 58 except in the single direction. The method may also include, if the user desires to remove trophy mount assembly 200 and attach a different trophy, disengaging the insert member 58 of mount assembly 200 from the mounting plate 10 by lifting it out of the slot 38 and notch 42, and then engaging the insert member 58 of another one of the mount assemblies 300, 400, 500 with the mounting plate 10.

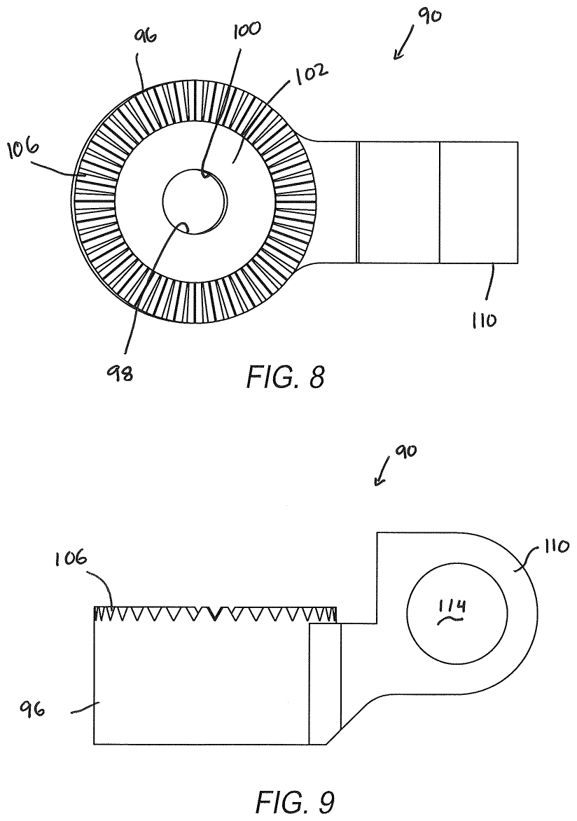

Some of the trophy mount assemblies include at least one joint assembly 86. Joint assembly 86 is selectively lockable and includes first and second joint members 90, 94. Joint member 90 is depicted in FIGS. 8 and 9. Joint members 90, 94 are substantially identical to one another, and thus joint member 90 is representative of joint member 94.

Referring specifically to FIGS. 8 and 9, joint member 90 includes a first portion 96 that defines a cylindrical bore 98 extending therethrough and having an opening 100 in surface 102. Surface 102 defines a plurality of teeth 106. Teeth 106 are arranged in an annulus having the centerline of bore 98 at its center. The teeth 106 extend radially relative to the centerline of bore 98. Joint member 90 also includes a second portion 110 that defines another cylindrical bore 114 extending therethrough. The centerline of bore 98 extends in first and second opposite directions. The centerline of bore 114 extends in third and fourth opposite directions that are perpendicular to the first and second directions.

Referring again to FIGS. 6 and 7, joint assembly 86 interconnects a mount apparatus 204 and the insert member 58 to provide three axes of rotation. More specifically, the second portion 110 of joint member 90 is positioned relative to the insert member 58 such that bore 114 is aligned with aperture 82; a cylindrical fastener 118 extends through aperture 82 and bore 114 to attach the joint assembly 86 to the insert member 58. Joint member 90 is selectively rotatable relative to the insert member 58 about fastener 118, thereby providing a vertical axis of rotation.

Joint member 94 is positioned relative to joint member 90 such that the bore 98 of joint member 90 is aligned with the bore 98 of joint member 94; surface 102 of joint member 90 contacts surface 102 of joint member 94 such that the teeth 106 of joint member 90 engage the teeth 106 of joint member 94. A fastener 122 extends through the bores 98 of both joint members 90, 94 so that the first portion 96 of joint member 90 is attached to the first portion 96 of joint member 94.

When the fastener 122 is tightened, the interlocking teeth 106 prevent rotation of joint member 90 relative to joint member 94. The fastener 122 may be loosened to permit disengagement of the teeth 106 so that joint member 94 may be rotated relative to joint member 90 about the fastener 122 and thereby alter the angular position of joint member 94; subsequently tightening the fastener 122 will secure the joint member 94 in its new angular position. Thus, fastener 122 provides a horizontal axis of rotation.

The second portion 110 of joint member 94 is connected to a trophy mount apparatus 204, which, in the embodiment depicted, includes a post 208 with a winged arm 210 to support a skull (not shown). The apparatus 204 is connected to the second portion 110 of joint member 94 via a fastener 212 that extends through the bore 114 in joint member 94, and thus the apparatus 204 is rotatable about fastener 212 and yet another axis (which is coextensive with the fastener 212 and with the centerline of the bore 114 in member 94).

The post 208 is coated with an elastomer 216, such as rubber, to increase the coefficient of friction of the post 208 and thereby improve the retention of a skull mounted thereon. The winged arm 210 includes a U-shaped bracket portion 220 and a collar 224 that defines an aperture 228. The post 208 extends through the aperture 228 so that the collar 224 and U-shaped bracket portion 220 are selectively rotatable about the post 208. A set screw 232 extends through the collar such that tightening the set screw 232 prevents rotation of the winged arm 210. The rotatability of the U-shaped bracket member enables fine-tune adjustments.

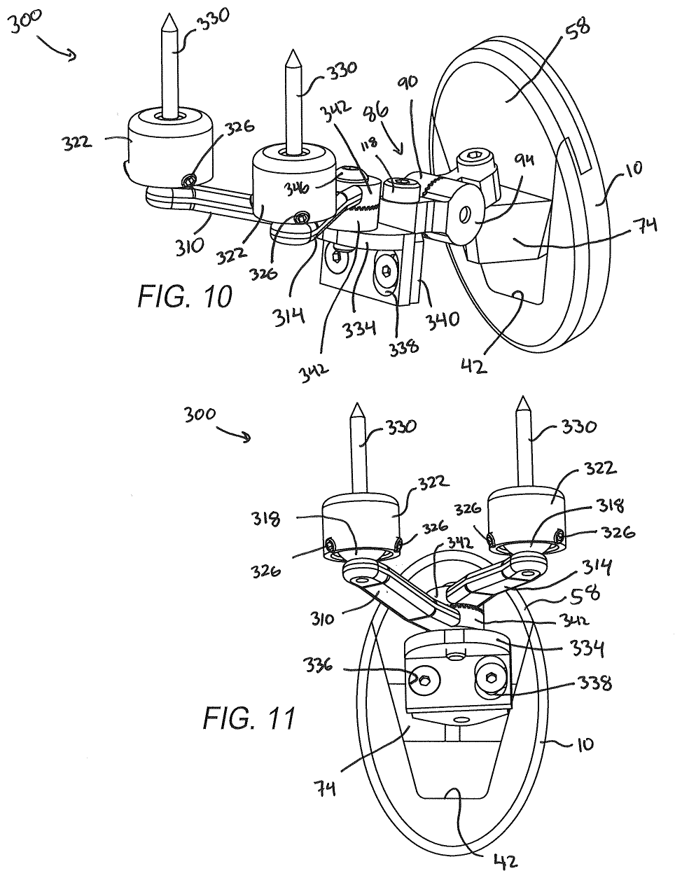

Referring to FIGS. 10 and 11, trophy mount assembly 300 includes a joint assembly 86 that interconnects an antler mounting apparatus to an insert member 58, thereby providing three axes of rotation and adjustability. The antler mounting apparatus includes two arms 310, 314 each having a spherical ball 318 attached at one end. The antler mounting apparatus includes two metal caps 322, each covering a respective one of the balls 318 such that the caps are 322 are selectively swivelable (i.e., capable of swiveling) on one of the balls 318. Set screws 326 extend through each cap so that the set screws 326, when adequately tightened, engage the balls 318 to lock the caps 322 relative to the balls 318.

Posts 330 with sharp tips are mounted to a respective one of the caps 322; the posts 330 are insertable into the base of antlers to retain them. The arms 310, 314 are mounted to a member 334 defining a hole 336 and an arcuate slot 338. Fasteners extend through the hole 336 and the slot 338 to connect the member 334 to member 340. Member 340 is connected to joint member 94 via fastener 118 so that member 340 is rotatable about the fastener 118. The arcuate slot 338 permits angular adjustment of member 334 relative to member 340.

Ends 342 of arms 310, 314 are substantially similar to portion 96 of joint members 90, 94. A fastener 346 extends through a hole in each of the ends 342 so that the arms 310, 314 are rotatably connected to member 334 and the distance between posts 330 is selectively adjustable. Teeth on ends 342 engage one another to lock the angular position of arms 310, 314 relative to one another upon tightening of fastener 342.

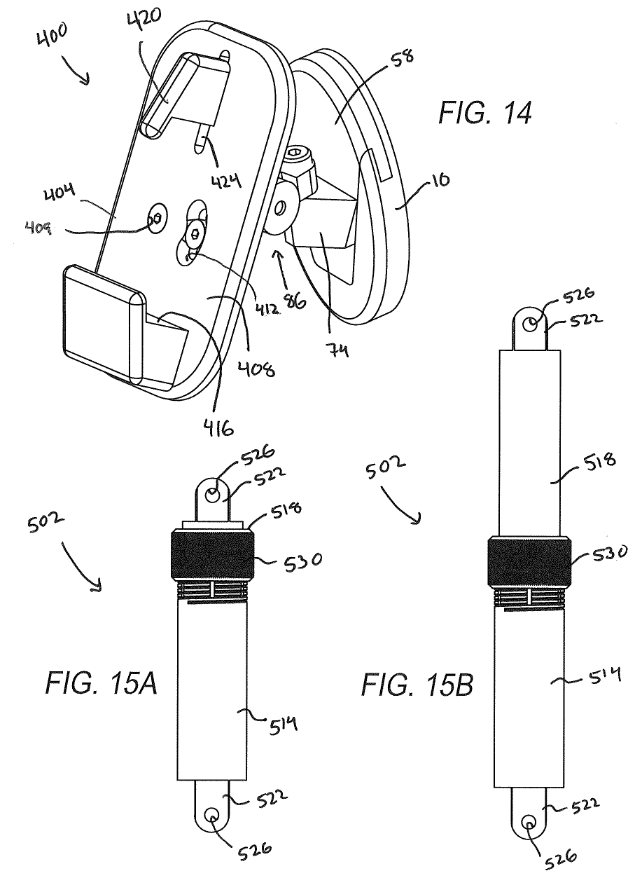

Referring to FIG. 14, trophy mounting assembly 400 includes insert member 58 and skull plate mounting apparatus 404 mounted thereto. Mounting apparatus 404 includes a plate 408 defining a hole 409 and an arcuate slot 412 extending therethrough. Fasteners extend through the hole 409 and the slot 412 to connect the plate 408 to the insert member 58. A ledge 416 protrudes from plate 408 to support a skull plate (not shown). A hook 420 extends through a slot 424 in plate 408 to secure the upper edge of the skull plate (not shown). The hook 420 is slidable up and down within the slot 424 to accommodate skull plates of different sizes. A joint assembly 86 operatively interconnects the mounting apparatus 404 to the insert member 58 and, correspondingly, to the mounting plate 10.

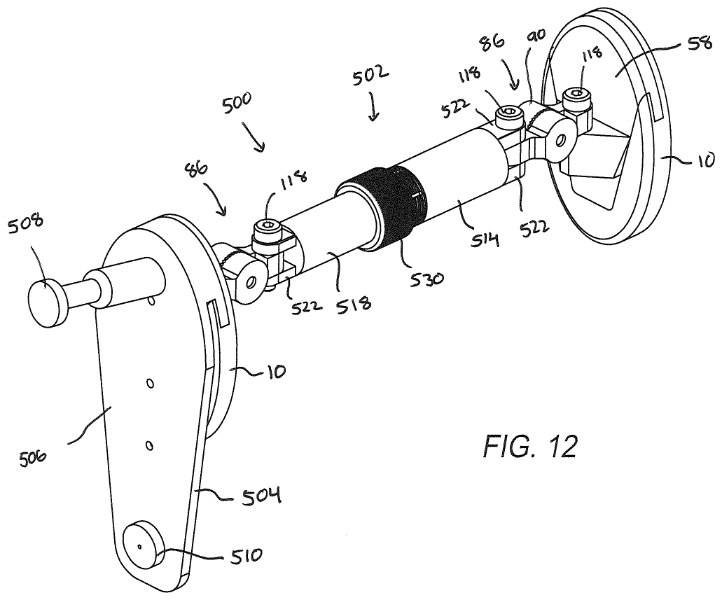

Referring to FIG. 12, assembly 500 includes an insert plate 58, a joint assembly 86 interconnecting the insert plate 58 and a telescoping arm assembly 502, another joint assembly 86 interconnecting the arm assembly 502 and another mounting plate 10, and a skull mounting apparatus 504 engaged with the mounting plate 10. Each joint assembly 86 provides three axes of adjustment, and the telescoping arm assembly 502 is selectively variable in length, as shown in FIGS. 15A and 15B. The arm assembly 502 includes two tubes, one being partially inserted into the other and being selectively slidable relative to the other.

More specifically, and with continued reference to FIG. 12, the skull mounting apparatus 504 includes a plate 506 having a T-post screw 508 protruding therefrom to hold a skull (including an artificial skull) in place. A rubber pad 510 is also mounted to the plate 506 to further hold the skull in place relative to the plate 506.

The telescoping tube assembly 502 includes a first tube 514 and a second tube 518. The second tube 518 extends into the first tube 514 as understood by those skilled in the art such that the second tube 518 is selectively slidable relative to the first tube 512, thereby making the length of the telescoping tube assembly 502 variable. For example, FIG. 15A depicts the telescoping tube assembly 502 with the second tube 518 fully inserted into the first tube 514 such that the telescoping tube assembly 502 has a first length that is minimized. FIG. 15B depicts the telescoping tube assembly 502 with the second tube 518 further retracted from the first tube 514 such that the telescoping tube assembly has a second length greater than the first length.

One end of the first telescoping tube 514 has protruding members 522 defining holes 526 for attachment to the joint assembly 86 that operatively connects the tube assembly 502 to the insert plate 58 (and, correspondingly, a mounting plate). More specifically, a fastener 118 extends through the holes 526 and the hole 114 in the second member 94 of the joint assembly 86 such that the first tube 514 is rotatable about the fastener relative to the second member 94. Accordingly, the joint assembly 86 provides three axes of rotation between the first tube 514 and the insert member 58 and mounting plate 10.

Similarly, one end of the second telescoping tube 518 also has protruding members 522, each defining a hole 526, for attachment of the second tube 518 to the other joint assembly 86 proximate to the skull mounting apparatus 504. Thus, the other joint assembly 86 provides three axes of rotation between the telescoping tube assembly 502 and the skill mounting apparatus 504.

The telescoping tube assembly 502 includes a locking mechanism 530 configured to selectively lock the second tube 518 relative to the first tube 514. Those skilled in the art will recognize various locking mechanisms 530 that may be employed within the claimed invention.

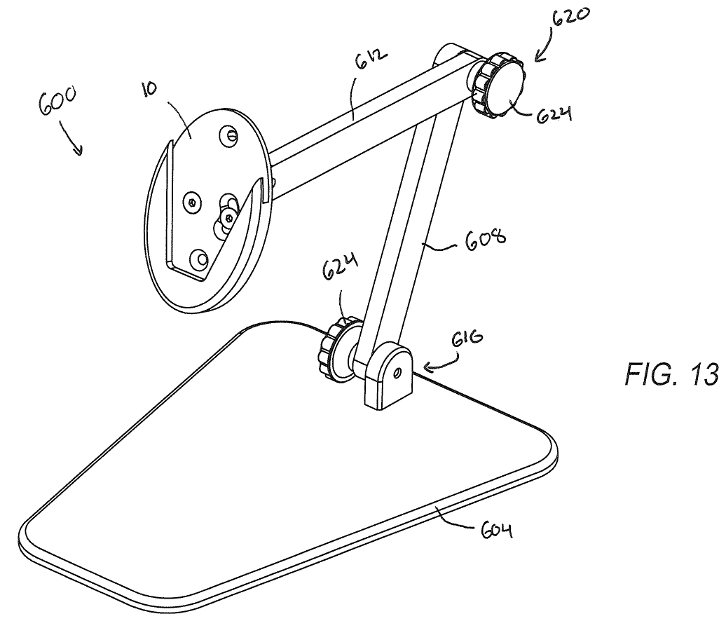

Referring to FIG. 13, a table-top display assembly 600 includes a base 604, a first link 608 pivotably connected to the base 604, a second link 612 pivotably connected to the first link 608, and a mounting plate 10 mounted to the second link 612. The mounting plate 10 permits any of the assemblies 200, 300, 400, 500 to be mounted to the table-top display 600 by engaging the insert member 58 of the assembly with the plate 10.

The base 604 includes a flat surface so that the base 604 is restable on a horizontal surface, such as a table top, desk top, etc. The first link 608 and the second link 612 form a counterbalance system for supporting one of the assemblies 200, 300, 400, 500. A first joint 616 interconnects the base 604 and the first link 608, a second joint 620 interconnects the first link 608 and the second link 612, and a third joint (not shown) may interconnect the second link 612 and the mounting plate 10.

Each joint 616, 620 provides a horizontal axis of rotation or pivot axis. Each joint 616, 620 includes a locking feature. In the embodiment depicted, the locking feature is a hand screw 624 that locks the joint 616, 620 when adequately tightened.

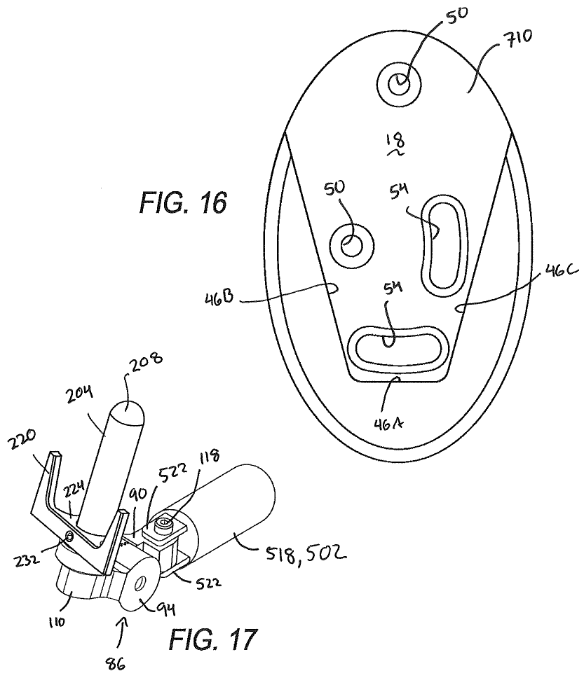

Referring to FIG. 16, an alternative mounting plate 710 is schematically depicted. Mounting plate 710 is identical to mounting plate 10 except that one of the holes 50 has been replaced by another arcuate slot 54.

FIG. 17 depicts one example of how the various components described herein may be used interchangeably. Referring to FIG. 17, the first tube 514 of telescoping tube assembly 502 is operatively connected to an insert member 58 and mounting plate 10 via a joint assembly 86 as shown in FIG. 12. However, the trophy mount apparatus 204 of FIGS. 6 and 7 is mounted to the second tube 518 via the other joint assembly 86.

While the best modes for carrying out the disclosure have been described in detail, those familiar with the art to which this disclosure relates will recognize various alternative designs and embodiments for practicing the disclosure within the scope of the appended claims.

1. A system for mounting hunting trophies, the system comprising:
a mounting plate configured for attachment to a wall;
a telescoping tube assembly having a first tube and a second tube;
the first tube being operatively connected to the mounting plate;
the second tube being in telescoping engagement with the first tube such that the length of the telescoping tube assembly is selectively variable; and
a trophy mount assembly being operatively connected to the second tube.

2. The system of claim 1, further comprising a joint assembly operatively interconnecting the first tube and the mounting plate;
said joint assembly including a first joint member that is selectively rotatable with respect to the mounting plate about a first axis;
said joint assembly including a second joint member that is selectively rotatable with respect to the first joint member about a second axis that is perpendicular to the first axis; and
said first tube being selectively rotatable with respect to the second joint member about a third axis that is perpendicular to the second axis.

3. The system of claim 2, further comprising a first pin that operatively interconnects the mounting plate and the first joint member and is coextensive with the first axis, a second pin that operatively interconnects the first and second joint members and is coextensive with the second axis, and a third pin that operatively interconnects the second joint member and the first tube and is coextensive with the third axis.

4. The system of claim 3, wherein the first and second joint members form a Hirth joint.

5. The system of claim 1, wherein the mounting plate defines a first surface and a second surface substantially parallel to the first surface, and at least one surface segment that interconnects the first surface and the second surface;
wherein the first surface, the second surface, and the at least one surface segment cooperate to define a slot; and
wherein the system further includes an insert member that is operatively connected to the first tube and at least partially inserted into the slot.

6. The system of claim 5, wherein the mounting plate allows movement of the insert member in only one direction when the insert member is fully inserted into the slot.

7. The system of claim 6, wherein said at least one surface segment includes a first surface segment, a second surface segment that forms a first angle with the first surface segment, and a third surface segment that forms a second angle with the first surface segment;
wherein the first angle is between 90 and 135 degrees; and
wherein the second angle is between 90 and 135 degrees.

8. The system of claim 7, wherein the mounting plate includes defines a notch; and
wherein a portion of the insert member extends through the notch.

9. The system of claim 8, wherein the mounting plate includes fourth, fifth, and sixth surface segments that cooperate to define the notch; and
wherein the fifth surface segment forms a third angle with the fourth surface segment;
wherein the sixth surface segment form a fourth angle with the fourth surface segment; and
wherein the third and fourth angles are between 90 and 135 degrees.

10. The system of claim 9, further comprising another trophy mount assembly connected to another insert member; said another insert member being identical to the insert member.

11. The system of claim 1, wherein the mounting plate defines a hole and a first arcuate slot.

12. The system of claim 11, wherein the mounting plate defines a second arcuate slot.

13. The system of claim 1, wherein the trophy mount assembly includes a post having an elastomeric coating; and
wherein the trophy mount assembly includes a U-shaped bracket having a collar defining an aperture;
wherein the post extends through the aperture in the collar such that the U-shaped bracket is rotatable about the post.

14. The system of claim 13, wherein the trophy mount assembly includes a set screw configured to selectively lock the U-shaped bracket relative to the post.

15. A method comprising:
possessing a mounting plate configured for attachment to a wall, a telescoping tube assembly having a first tube and a second tube in telescoping engagement with the first tube such that the length of the telescoping tube assembly is selectively variable, the first tube being operatively connected to the mounting plate, and a trophy mount assembly being operatively connected to the second tube; and
sliding the first tube relative to the second tube to change the length of the telescoping tube assembly and thereby change the distance of the trophy mount assembly relative to the mounting plate.

16. The method of claim 15, wherein the mounting plate defines a slot;
wherein the first tube is operatively connected to the mounting plate via an insert member that is inserted into the slot;
wherein the method further comprises removing the insert member from the slot to disconnect the first tube from the mounting plate.

17. The method of claim 16, further comprising possessing another trophy mount assembly having a different configuration from the trophy mount assembly, said another trophy mount assembly being operatively connected to another insert member, and
inserting said another insert member into the slot.
